(19) United States
(12) Patent Application Publication
(10) Pub. No.: US 2024/0417414 A1
(43) Pub. Date: Dec. 19, 2024

(54) PHOSPHOROUS FLAME RETARDANT, PRODUCT AND MANUFACTURING METHOD THEREOF

(71) Applicant: NAN YA PLASTICS CORPORATION, TAIPEI (TW)

(72) Inventors: Te-Chao Liao, TAIPEI (TW); Meng-Huai Han, TAIPEI (TW); Chi-Lin Chen, TAIPEI (TW)

(73) Assignee: NAN YA PLASTICS CORPORATION, TAIPEI (TW)

(21) Appl. No.: 18/358,030

(22) Filed: Jul. 25, 2023

(30) Foreign Application Priority Data
Jun. 14, 2023 (TW) 112122110

(51) Int. Cl. C07F 9/50; C07F 9/53; C08J 5/18; C09K 21/14

(52) U.S. Cl. CPC C07F 9/5054; C07F 9/5325; C08J 5/18; C09K 21/14; B29C 43/02; B29K 2105/0026; C08J 2343/02

(57) ABSTRACT

The disclosure provides a phosphorous flame retardant, a product and manufacturing methods thereof, and the phosphorous flame retardant has the chemical structure shown in the following Formula (3) or Formula (4):

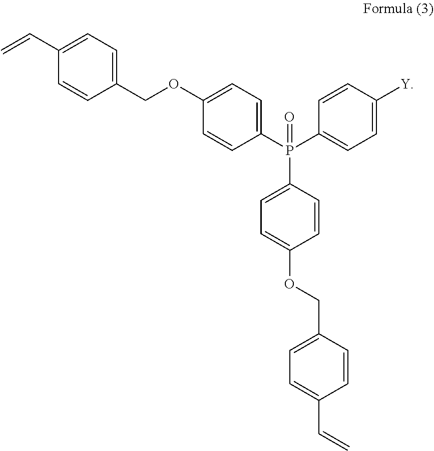

In Formula (3), Y is H, F, Cl, or Br.

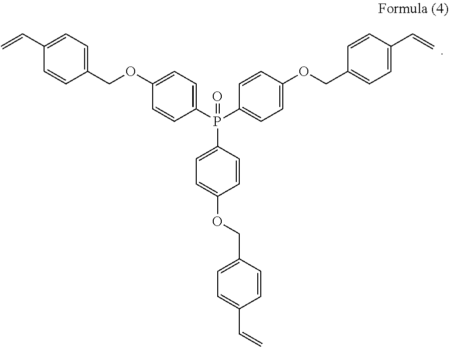 [SMILES: C=Cc1ccc(COc2ccc(P(=O)(c3ccc(OCc4ccc(C=C)cc4)cc3)c3ccc(OCc4ccc(C=C)cc4)cc3)cc2)cc1]

### CROSS-REFERENCE TO RELATED APPLICATION

This application claims the priority benefit of Taiwan application serial no. 112122110, filed on Jun. 14, 2023. The entirety of the above-mentioned patent application is hereby incorporated by reference herein and made a part of this specification.

### BACKGROUND

### Technical Field

The disclosure relates to a retardant, a product and a manufacturing method thereof, and more particularly, to a phosphorous flame retardant, a product and a manufacturing method thereof.

### Description of Related Art

Retardant is a chemical that prevents objects from burning, and may be added to products such as building materials, textiles, or vehicle interiors to improve their fire resistance. Many countries have relevant fire resistance standards and regulations, requiring the use of retardant to improve the fire resistance of buildings and products. Therefore, the development of new retardant technology has become an important field in the chemical industry today. Conventional retardants may no longer meet the stringent requirements for dielectric properties in the future.

Based on the above, the development of a low dielectric reaction retardant as a novel fire-resistant material with both a low dielectric constant and a high fire resistance is desired by professionals in the field. This retardant can be applied in fields demanding a high standard of fire resistance, such as electronic products and power equipment.

### SUMMARY

The disclosure provides a phosphorous flame retardant, a product and manufacturing method thereof. The phosphorous flame retardant has a novel phosphorous flame retardant modified structure, which is a structure composed of styrene functional group and a phosphorus backbone and has low dielectric constant and high fire resistance.

The manufacturing method of the phosphorous flame retardant of the disclosure includes the following process. A retardant containing phenolic functional group and chloromethylstyrene are added to a reaction tank, and butanone as a solvent and potassium iodide are added for stirring. The solvent is drained and placed in an oven after stirring to produce a phosphorous flame retardant. The retardant containing phenolic functional group has a chemical structure shown in following Formula (1). The chloromethylstyrene has a chemical structure shown in following Formula (2). The phosphorous flame retardant has a chemical structure shown in following Formula (3) or Formula (4):

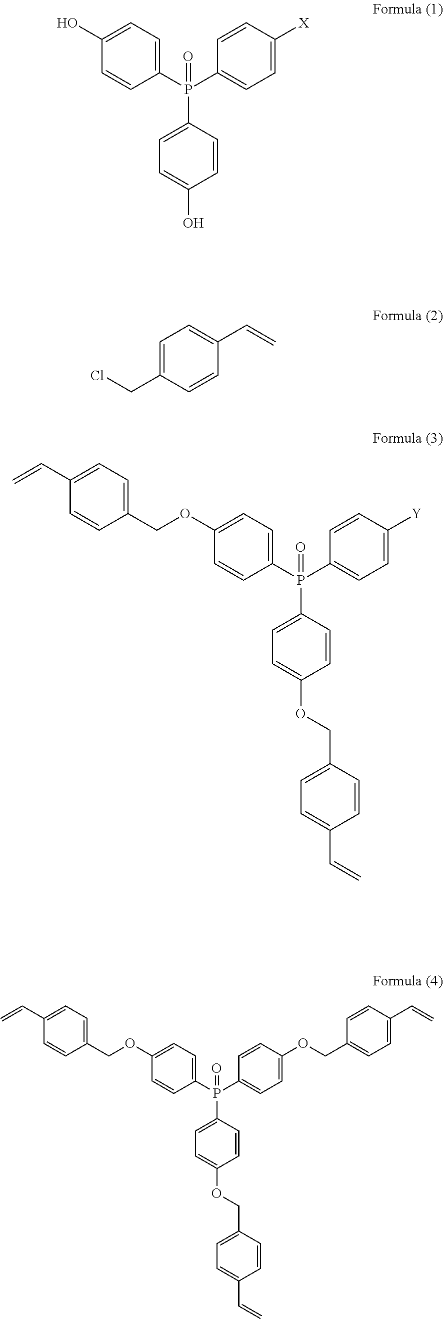

In Formula (1), X is H, OH, F, Cl, or Br.

In response to X in Formula (1) being H, F, Cl, or Br, the phosphorous flame retardant produced has the chemical structure shown in Formula (3). In Formula (3), Y is H, F, Cl, or Br.

In response to X in Formula (1) being OH, the phosphorous flame retardant produced has the chemical structure shown in Formula (4).

In an embodiment of the disclosure, a molar ratio of the retardant containing phenolic functional group to the chloromethylstyrene is 0.1 to 5.

In an embodiment of the disclosure, based on a total weight of the retardant containing phenolic functional group and the chloromethylstyrene, an amount of the solvent added is 100 phr to 200 phr.

In an embodiment of the disclosure, based on a total weight of the retardant containing phenolic functional group and the chloromethylstyrene, an amount of the potassium iodide added is 1 phr to 10 phr.

In an embodiment of the disclosure, a stirring speed is 60 rpm to 600 rpm, a stirring time is 12 hours to 48 hours, and a stirring temperature is 50° C. to 90° C.

In an embodiment of the disclosure, a temperature of the oven is 80° C. to 120° C., and a storage time in the oven is 1 hour to 6 hours.

The phosphorous flame retardant of the disclosure is produced by the aforementioned manufacturing method for phosphorous flame retardant. The phosphorous flame retardant has a chemical structure shown in following Formula (3) or Formula (4):

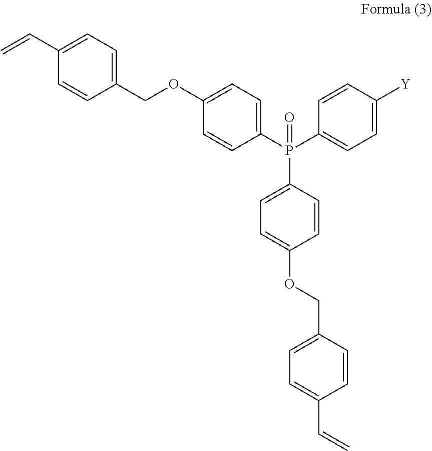

In Formula(3) Y is H F Cl or Br.

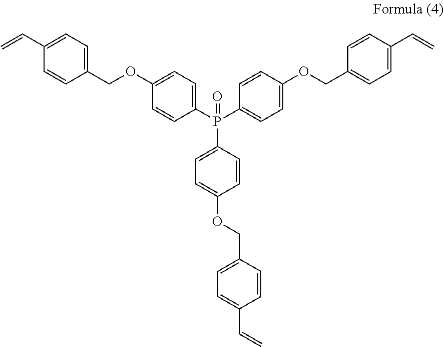 [SMILES: C=Cc1ccc(COc2ccc(P(=O)(c3ccc(OCc4ccc(C=C)cc4)cc3)c3ccc(OCc4ccc(C=C)cc4)cc3)cc2)cc1]

The product of the disclosure is made of the aforementioned phosphorous flame retardant. The product includes a resin sheet.

The manufacturing method of the product of the disclosure includes the following process. Butanone is used as a solvent, the aforementioned phosphorous flame retardant and a cross-linking accelerator are stirred and placed in a vacuum oven to remove the solvent to obtain a mixture. The mixture is ground into powder and filled into a mold, and a hot press is used for compressing to produce the product. The cross-linking accelerator includes a peroxide, the peroxide includes Luf, and the product includes a resin sheet.

In an embodiment of the disclosure, a weight ratio of the phosphorous flame retardant and the cross-linking accelerator is 50 to 500.

In an embodiment of the disclosure, based on the total weight of the phosphorous flame retardant and the cross-linking accelerator, an amount of the solvent added is 100 phr to 200 phr.

In an embodiment of the disclosure, a stirring speed is 40 rpm to 400 rpm, a stirring time is 0.5 hour to 2 hours, and a stirring temperature is 50° C. to 75° C.

In an embodiment of the disclosure, a temperature of the oven is 80° C. to 120° C., and a storage time in the oven is 1 hour to 6 hours.

In an embodiment of the disclosure, a compressing time of the hot press is 1 hour to 6 hours, and a temperature is 150° C. to 300° C.

The compressed resin sheet should meet the following specifications for subsequent measurement of the dielectric constant: a thickness ranging from 0.3 m to 1.3 m and square dimensions ranging from 3 cm to 13 cm.

Based on the above, the disclosure provides a phosphorous flame retardant, a product and manufacturing method thereof. The phosphorous flame retardant has a novel phosphorous flame retardant modified structure, which is a structure composed of a styrene functional group and a phosphorus backbone. Unlike conventional additives, this retardant may be regarded as a reactive retardant resin with both a low dielectric constant and a high fire resistance, which may be applied in fields demanding a high standard of fire resistance, such as electronic products and power equipment.

### DESCRIPTION OF THE EMBODIMENTS

The embodiments of the disclosure are described in detail below. However, these embodiments are exemplary and the disclosure is not limited thereto.

In addition, herein, the range indicated by “one numerical value to another numerical value” is a general representation which avoids enumerating all numerical values in the stated range one by one in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

The manufacturing method of the phosphorous flame retardant of the disclosure includes the following process. A retardant containing phenolic functional group and chloromethylstyrene are added to a reaction tank, and butanone as a solvent and potassium iodide are added for stirring. The solvent is drained and placed in an oven after stirring to produce a phosphorous flame retardant. The retardant containing phenolic functional group has a chemical structure shown in following Formula (1). The chloromethylstyrene has a chemical structure shown in following Formula (2). The phosphorous flame retardant has a chemical structure shown in following Formula (3) or Formula (4):

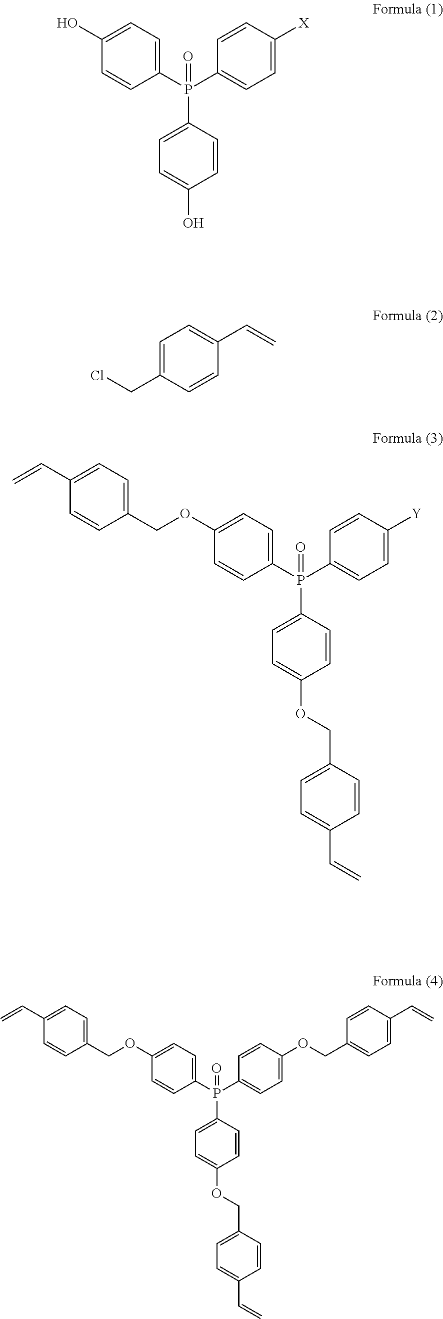

In Formula (1), X is H, OH, F, Cl, or Br.

In response to X in Formula (1) being H, F, Cl, or Br, the phosphorous flame retardant produced has the chemical structure shown in Formula (3). In Formula (3), Y is H, F, Cl, or Br.

In response to X in Formula (1) being OH, the phosphorous flame retardant produced has the chemical structure shown in Formula (4).

In this embodiment, a molar ratio of the retardant containing phenolic functional group to the chloromethylstyrene is, for example, 0.1 to 5. Based on a total weight of the retardant containing phenolic functional group and the chloromethylstyrene, an amount of the solvent added is, for example, 100 phr to 200 phr, and an amount of the potassium iodide added is, for example, 1 phr to 10 phr. A stirring speed is, for example, 60 rpm to 600 rpm, a stirring time is, for example, 12 hours to 48 hours, and a stirring temperature is, for example, 50° C. to 90° C. A temperature of the oven is, for example, 80° C. to 120° C., and a storage time in the oven is, for example, 1 hour to 6 hours.

The disclosure also provides a phosphorous flame retardant, which is produced by the manufacturing method of the aforementioned phosphorous flame retardant. The phosphorous flame retardant has the chemical structure shown in following Formula (3) or Formula (4):

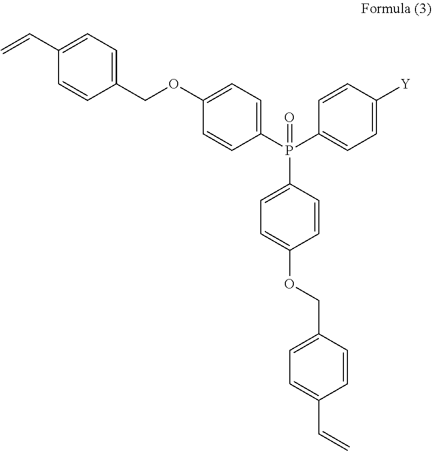

In Formula (3), Y is H, F, Cl, or Br.

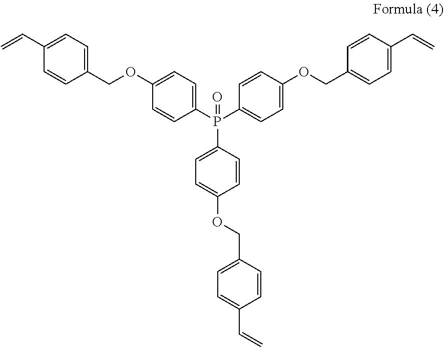 [SMILES: C=Cc1ccc(COc2ccc(P(=O)(c3ccc(OCc4ccc(C=C)cc4)cc3)c3ccc(OCc4ccc(C=C)cc4)cc3)cc2)cc1]

The disclosure also provides a product made of the aforementioned phosphorous flame retardant, and the product may include a resin sheet, such as a 5G high frequency substrate, but the disclosure is not limited thereto.

The manufacturing method of the product of the disclosure includes the following process. Butanone is used as a solvent, the aforementioned phosphorous flame retardant and a cross-linking accelerator are stirred and placed in a vacuum oven to remove the solvent to obtain a mixture. The mixture is ground into powder and filled into a mold, and a hot press is used for compressing to produce the product. The cross-linking accelerator may include a peroxide, the peroxide may include Luf, and the product may include a resin sheet, such as a 5G high frequency substrate.

In this embodiment, a weight ratio of the phosphorous flame retardant and the cross-linking accelerator is, for example, 50 to 500. Based on the total weight of the phosphorous flame retardant and the cross-linking accelerator, an amount of the solvent added is 100 phr to 200 phr. A stirring speed is, for example, 40 rpm to 400 rpm, a stirring time is, for example, 0.5 hour to 2 hours, and a stirring temperature is, for example, 25° C. to 75° C. A temperature of the oven is, for example, 80° C. to 120° C., and a storage time in the oven is, for example, 1 hour to 6 hours. A compressing time of the hot press is, for example, 1 hour to 6 hours, and a temperature is, for example, 150° C. to 300° C.

In the following, the aforementioned phosphorous flame retardant and the product thereof of the disclosure are described in detail by an experimental example. However, the following experimental examples are not intended to limit the present invention.

### Experimental Example

To demonstrate that the phosphorous flame retardant of the disclosure enables the product of resin sheet to have both a low dielectric constant and a high fire resistance, the following experimental example is provided.

### Testing Method

Dielectric constant Dk: dielectric constant Dk at a frequency of 10 GHz was tested with a dielectric Analyzer HP Agilent E4991A

Dielectric loss Df: dielectric loss Df at a frequency of 10 GHz was tested with a dielectric Analyzer HP Agilent E4991A.

### Preparation and Test Evaluation of the Phosphorous Flame Retardant and the Product Thereof

### Example 1

1 mol of retardant containing phenolic functional group having the chemical structure shown in Formula (1) and 2.5 mol of chloromethylstyrene were added into the reaction tank. Next, butanone as a solvent and potassium iodide were added for stirring at 80° C. for 24 hours. The solvent was drained and placed in an oven after stirring. The temperature of the oven was 100° C. After confirming that the solvent was removed, the phosphorous flame retardant with the chemical structure shown in Formula (3) was produced. Then, with butanone as the solvent, 25 grams of the resulting phosphorous flame retardant and 0.25 grams of cross-linking accelerator Luf were stirred for 30 minutes, and then placed in a vacuum oven at 1000 C for 3 hours to remove the solvent to obtain a mixture. Next, the mixture was ground into powder and filled into a mold, and a hot press was used for compressing at 200° C. for 2 hours to produce the product of a resin sheet.

### Example 2

Basically, the preparation of the phosphorous flame retardant and the product thereof were the same as the preparation conditions and methods in Example 1. The difference was that in Example 2, the retardant containing phenolic functional group had the chemical structure shown in Formula (1), where X in Formula (1) is OH. Thus, the phosphorous flame retardant produced had the chemical structure shown in Formula (4).

### Comparative Example 1

Basically, the preparation of the phosphorous flame retardant and the product thereof were the same as the preparation conditions and methods in Example 1. The difference was that the retardant containing phenolic functional group having the chemical structure shown in Formula (1) and the chloromethylstyrene were respectively replaced by a retardant having the chemical structure shown in Formula (5) and a commercial product, NORYL SA9000 SABIC, having the chemical structure shown in Formula (6).

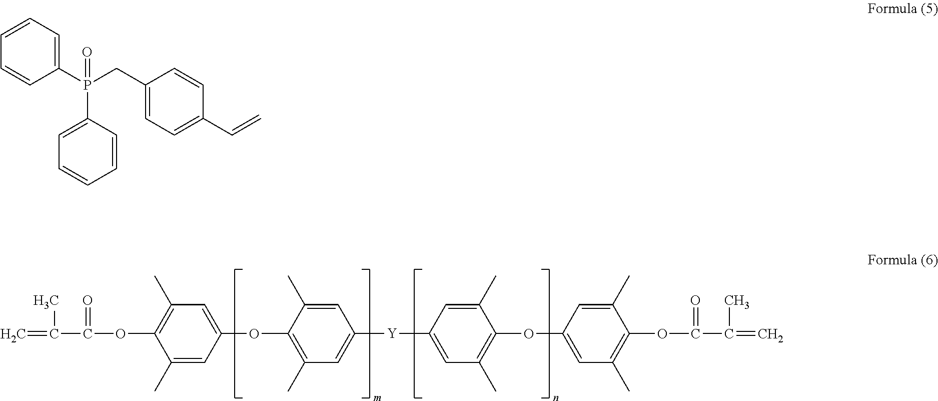

### Comparative Example 2

Basically, the preparation of the phosphorous flame retardant and the product thereof were the same as the preparation conditions and methods in Comparative Example 1. The difference was that the retardant having the chemical structure shown in Formula (5) was replaced by a retardant having the chemical structure shown in Formula (7).

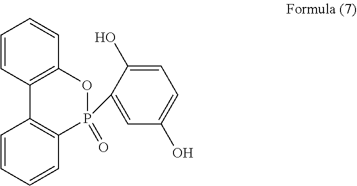 [SMILES: O=P1(c2cc(O)ccc2O)Oc2ccccc2-c2ccccc21]

### Comparative Example 3

Basically, the preparation of the phosphorous flame retardant and the product thereof were the same as the preparation conditions and methods in Comparative Example 1. The difference was that the retardant having the chemical structure shown in Formula (5) was replaced by a retardant having the chemical structure shown in Formula (8).

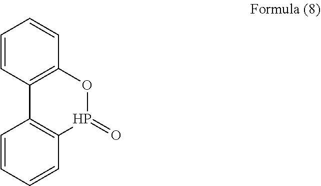

The testing results of Example 1, Example 2, and Comparative example 1 to Comparative example 3 are shown in Table 1 below. It may be known that under the same reaction preparation conditions, in Example 1 and Example 2, the phosphorous flame retardant made of the retardant containing phenolic functional group and the chloromethylstyrene of the disclosure had a structure composed of a styrene functional group and a phosphorus backbone and thus had both a low dielectric constant and a high fire resistance. In contrast, Comparative example 1 to Comparative example 3, which used conventional DOPO retardants, had the disadvantage of being unable to react with the existing resin, resulting in poor dielectric constant and dielectric loss.

TABLE 1

| | | | Compar- | Compar- | Compar- |
|---|---|---|---|---|---|
| | Experi- | Experi- | ative | ative | ative |
| | mental | mental | Embodi- | Embodi- | Embodi- |
| | example | example | ment | ment | ment |
| | 1 | 2 | 1 | 2 | 3 |
| Dk@ | 2.77 | 2.77 | 3.23 | 3.57 | 5.11 |
| 10 GHz | | | | | |
| Df@ | 0.0062 | 0.0064 | 0.0111 | 0.0173 | 0.0255 |
| 10 GHz | | | | | |

To sum up, the disclosure provides a phosphorous flame retardant, a product and manufacturing method thereof. The phosphorous flame retardant has a novel phosphorous flame retardant modified structure, which is a structure composed of a styrene functional group and a phosphorus backbone. Unlike conventional additives, this retardant may be regarded as a reactive retardant resin with both a low dielectric constant and a high fire resistance. The product of resin sheet has a dielectric constant (@10 GHz) of less than 3.0/a dielectric loss (@10 GHz) of less than 0.0080, which are superior to conventional retardants (dielectric constant (@10 GHz) of greater than 3.0/dielectric loss (@10 GHz) of greater than 0.0100) and thus may be applied in fields demanding a high standard of fire resistance, such as electronic products and power equipment.

What is claimed is:

1. A manufacturing method for phosphorous flame retardant, comprising:
adding a retardant containing phenolic functional group and chloromethylstyrene to a reaction tank and adding butanone as a solvent and potassium iodide for stirring; and
draining the solvent and placing in an oven after stirring to produce a phosphorous flame retardant,
wherein the retardant containing phenolic functional group has a chemical structure shown in following Formula (1), the chloromethylstyrene has a chemical structure shown in following Formula (2), and the phosphorous flame retardant has a chemical structure shown in following Formula (3) or Formula (4): 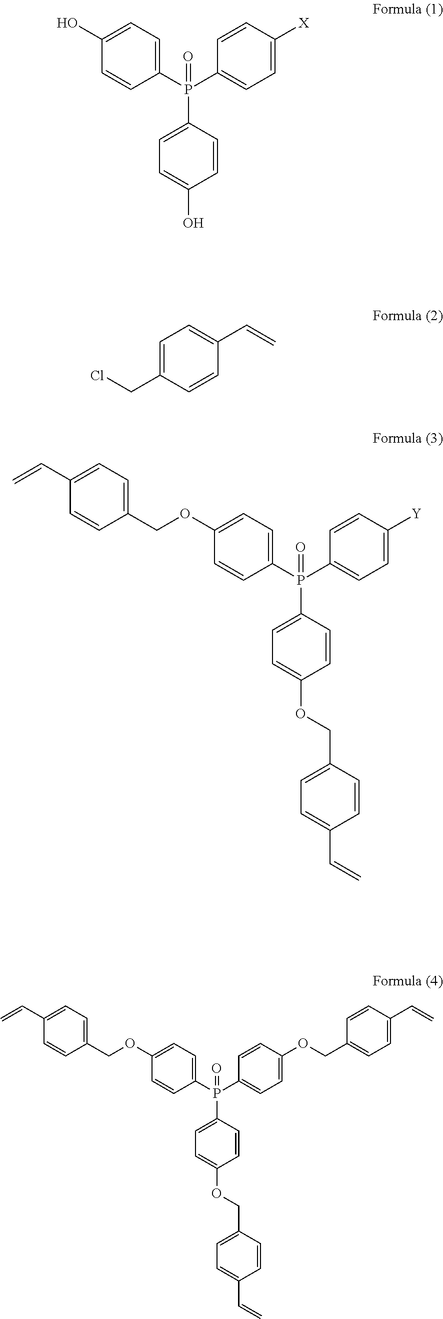
in Formula (1), X is H, OH, F, Cl, or Br,
in response to X in Formula (1) being H, F, Cl, or Br, the phosphorous flame retardant produced has the chemical structure shown in Formula (3), in Formula (3), Y is H, F, Cl, or Br, and
in response to X in Formula (1) being OH, the phosphorous flame retardant produced has the chemical structure shown in Formula (4).

2. The manufacturing method for phosphorous flame retardant according to claim 1, wherein a molar ratio of the retardant containing phenolic functional group to the chloromethylstyrene is 0.1 to 5.

3. The manufacturing method for phosphorous flame retardant according to claim 1, wherein based on a total weight of the retardant containing phenolic functional group and the chloromethylstyrene, an amount of the solvent added is 100 phr to 200 phr.

4. The manufacturing method for phosphorous flame retardant according to claim 1, wherein based on a total weight of the retardant containing phenolic functional group and the chloromethylstyrene, an amount of the potassium iodide added is 1 phr to 10 phr.

5. The manufacturing method for phosphorous flame retardant according to claim 1, wherein a stirring speed is 60 rpm to 600 rpm, a stirring time is 12 hours to 48 hours, and a stirring temperature is 50° C. to 90° C.

6. The manufacturing method for phosphorous flame retardant according to claim 1, wherein a temperature of the oven is 80° C. to 120° C., and a storage time in the oven is 1 hour to 6 hours.

7. A phosphorous flame retardant, produced by the manufacturing method for phosphorous flame retardant according to claim 1, wherein the phosphorous flame retardant has a chemical structure shown in following Formula (3) or Formula (4): 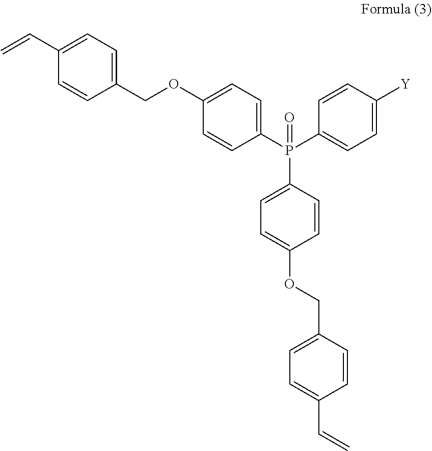
in Formula (3), Y is H, F, Cl, or Br,

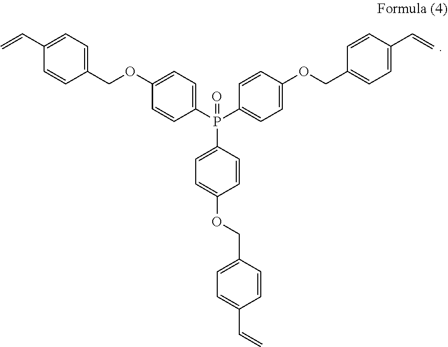 [SMILES: C=Cc1ccc(COc2ccc(P(=O)(c3ccc(OCc4ccc(C=C)cc4)cc3)c3ccc(OCc4ccc(C=C)cc4)cc3)cc2)cc1]

8. A product made of the phosphorous flame retardant according to claim 7, wherein the product comprises a resin sheet.

9. A manufacturing method for a product, comprising:
using butanone as a solvent, stirring the phosphorous flame retardant according to claim 7 and a cross-linking accelerator, and placing in a vacuum oven to remove the solvent to obtain a mixture;
grinding the mixture into powder and filling into a mold, and using a hot press for compressing to produce the product,
wherein the cross-linking accelerator comprises a peroxide, the peroxide comprises Luf, and the product comprises a resin sheet.

10. The manufacturing method for the product according to claim 9, wherein a weight ratio of the phosphorous flame retardant and the cross-linking accelerator is 50 to 500.

11. The manufacturing method for the product according to claim 9, wherein based on a total weight of the phosphorous flame retardant and the cross-linking accelerator, an amount of the solvent added is 100 phr to 200 phr.

12. The manufacturing method for the product according to claim 9, wherein a stirring speed is 40 rpm to 400 rpm, a stirring time is 0.5 hour to 2 hours, and a stirring temperature is 25° C. to 75° C.

13. The manufacturing method for the product according to claim 9, wherein a temperature of the oven is 80° C. to 120° C., and a storage time in the oven is 1 hour to 6 hours.

14. The manufacturing method for the product according to claim 9, wherein a compressing time of the hot press is 1 hour to 6 hours, and a temperature is 150° C. to 300° C.
